(19) United States
(12) Patent Application Publication
(10) Pub. No.: US 2019/0065102 A1
(43) Pub. Date: Feb. 28, 2019

(54) MEMORY SYSTEM AND OPERATING METHOD THEREOF

(71) Applicant: SK hynix Inc., Gyeonggi-do (KR)

(72) Inventors: Soong Sun SHIN, Gyeonggi-do (KR); Jin Soo KIM, Gyeonggi-do (KR); Han CHOI, Seoul (KR)

(21) Appl. No.: 15/944,958

(22) Filed: Apr. 4, 2018

(30) Foreign Application Priority Data
Aug. 29, 2017 (KR) 10-2017-0109220

(51) Int. Cl. G06F 3/06; G06F 17/30

(52) U.S. Cl. CPC G06F 3/0656; G06F 3/0679; G06F 3/061; G06F 17/30979

(57) ABSTRACT

There are provided a memory system and an operating method thereof. An operating method of a memory system includes: receiving a read command from a host; a first search process of search for data corresponding to the read command in a controller memory buffer; and a first transfer process of transferring the data to the host, wherein the controller memory buffer is accessible by the host.

### CROSS-REFERENCE TO RELATED APPLICATION

The present application claims priority under 35 U.S.C. § 119(a) to Korean patent application number 10-2017-0109220, filed on Aug. 29, 2017, the entire disclosure of which is herein incorporated by reference.

### BACKGROUND

### 1. Field of Invention

Various embodiments of the present disclosure relates to a memory system. Particularly, the embodiments relate to a memory system with decreased read latency, and an operating method thereof.

### 2. Description of Related Art

A memory system may include a nonvolatile memory device, a memory controller, and a memory buffer. When the memory system receives a read command from a host, the memory system may read data corresponding to the read command from the memory device and output the read data to the host.

A flash memory device is frequently used as the nonvolatile memory device. Threshold voltages of a plurality of programmed memory cells in the flash memory device may be changed depending on several factors, e.g., floating gate coupling, charge loss with elapse of time, and the like. The change of threshold voltages of the plurality of memory cells may cause fail of a read operation. In order to prevent the fail of the read operation, an optimum read voltage may be searched, and the read operation may be retried using the searched optimum read voltage. Such a read retry operation results in degradation of the read performance of the nonvolatile memory device.

Such a long read time may frequently result in degradation of the entire read performance of the memory system. Thus, a technique for improving the read performance of the memory system is needed.

### SUMMARY

Embodiments provide a memory system with decreased read latency, and an operating method thereof.

According to an aspect of the present disclosure, there is provided a method for operating a memory system, the method including: receiving a read command from a host; a first search process of searching for data corresponding to the read command in a controller memory buffer; and a first transfer process of transferring the data to the host, wherein the controller memory buffer is accessible by the host.

According to an aspect of the present disclosure, there is provided a method for operating a memory system, the method including: receiving a read command from a host; a first search process of searching for data corresponding to the read command in a controller memory buffer; a second search process of searching for the data in a device memory buffer; a read process of reading the data from a memory device; and an output process of outputting the data to the host, wherein the controller memory buffer is occupied by the host.

According to an aspect of the present disclosure, there is provided a memory system including: a memory device; and a memory controller, wherein the memory controller includes: a controller memory buffer including a completion queue and a command queue; and a device memory buffer, wherein, when a read command is input from a host, the memory controller searches for data corresponding to the read command in the completion queue, wherein the controller memory buffer is shared by the host and the memory controller.

According to an aspect of the present disclosure, there is provided a data processing system including: a memory device; and a controller suitable for controlling the memory device to perform a read operation in response to a request from a host. The controller includes a first level cache and a second level cache. The second level cache is suitable for serving as a cache for the memory device. The first level cache is suitable for serving as a cache for the second level cache. The controller stores read data in the first level cache as a result of the read operation. The host accesses the first level cache to obtain read data through a nonvolatile memory express (NVMe) interface.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a memory system according to an embodiment of the present disclosure.

FIG. 2 is a diagram illustrating a memory controller of FIG. 1.

FIG. 3 is a diagram illustrating a memory device of FIG. 1.

FIG. 4 is a diagram illustrating in detail a memory buffer according to an embodiment of the present disclosure.

FIG. 5 is a flowchart illustrating a method of processing a write command according to an embodiment of the present disclosure.

FIG. 6 is a flowchart illustrating a method of processing a read command according to an embodiment of the present disclosure.

FIG. 7 is a flowchart illustrating a method of processing a read command according to another embodiment of the present disclosure.

FIGS. 8 to 11 are diagrams illustrating various exemplary embodiments of the memory system including the memory controller shown in FIG. 2 and the memory device shown in FIG. 3.

### DETAILED DESCRIPTION

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive.

In the entire specification, when an element is referred to as being “connected” or “coupled” to another element, it can be directly connected or coupled to the another element or be indirectly connected or coupled to the another element with one or more intervening elements interposed therebetween.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

The terminology used herein is for the purpose of describing particular embodiments only and is not intended to be limiting of the present invention.

As used herein, singular forms may include the plural forms as well, unless the context clearly indicates otherwise.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

Hereinafter, the various embodiments of the present invention will be described in detail with reference to the attached drawings.

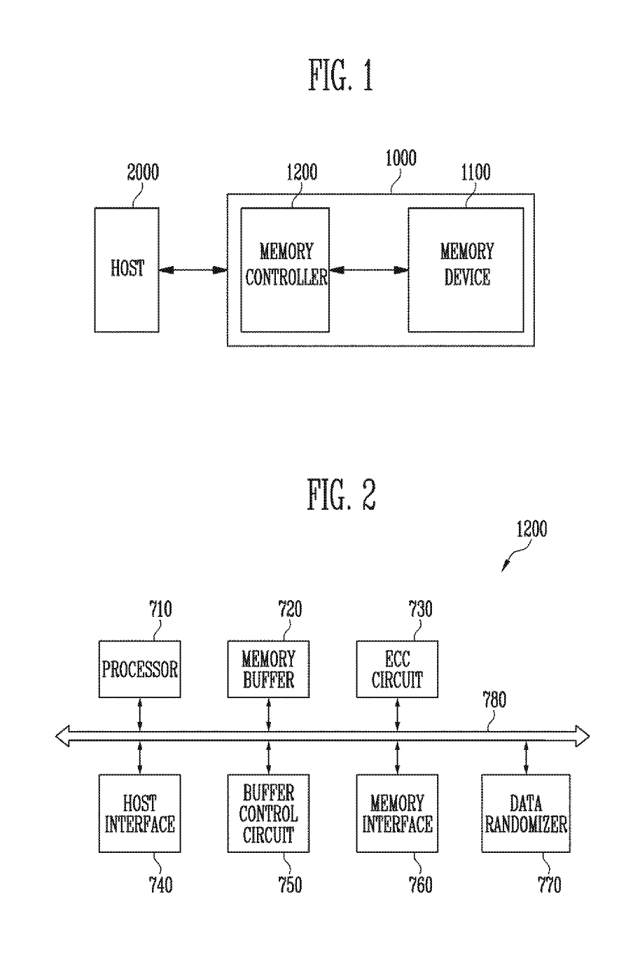

FIG. 1 is a diagram illustrating a memory system according to an embodiment of the present disclosure.

Referring to FIG. 1, the memory system 1000 may include a memory device 1100 that stores data and a memory controller 1200 that controls the memory device 1100 under the control of a host 2000.

The host 2000 may communicate with the memory system 1000 by using an interface protocol such as peripheral component interconnect-express (PCI-E), advanced technology attachment (ATA), serial ATA (SATA), parallel ATA (PATA), or serial attached SCSI (SAS). In addition, interface protocols between the host 2000 and the memory system 1000 are not limited to the above-described examples, and may be one of other interface protocols such as a universal serial bus (USB), a multi-media card (MMC), an enhanced small disk interface (ESDI), and integrated drive electronics (IDE).

The memory controller 1200 may control overall operations of the memory system 1000, and control data exchange between the host 2000 and the memory device 1100. For example, the memory controller 1200 may program or read data by controlling the memory device 1100 in response to a request of the host 2000. Also, the memory controller 1200 may store information on main memory blocks and sub-memory blocks, which are included in the memory device 1100, and select the memory device 1100 to perform a program operation on the main memory block or the sub-memory block according to the amount of data loaded for the program operation. In some embodiments, the memory device 1100 may include a double data rate synchronous dynamic random access memory (DDR SDRAM), a low power double data rate 4 (LPDDR4) SDRAM, a graphics double data rate (GDDR) SRAM, a low power DDR (LPDDR), a rambus dynamic random access memory (RDRAM), and a flash memory.

The memory device 1100 may perform a program, read, or erase operation under the control of the memory controller 1200.

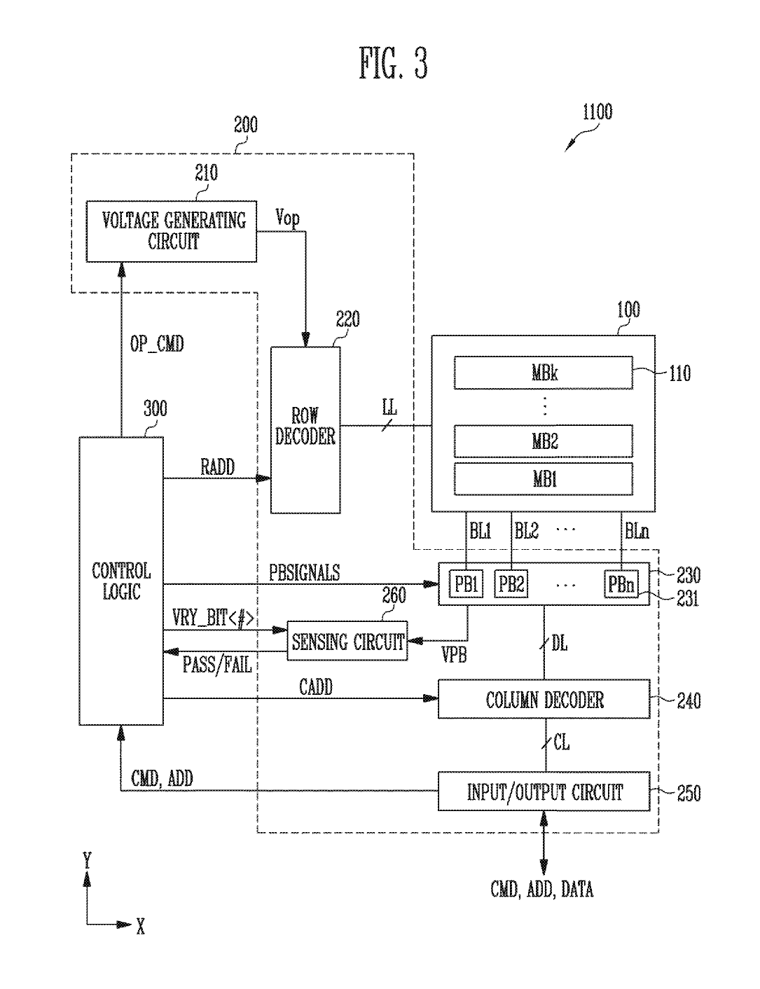

FIG. 2 is a diagram illustrating the memory controller of FIG. 1.

Referring to FIG. 2, the memory controller 1200 may include a processor 710, a memory buffer 720, an error correction code (ECC) circuit 730, a host interface 740, a buffer control circuit 750, a memory interface 760, and a bus 780.

The bus 780 may provide channels between components of the memory controller 1200.

The processor 710 may control overall operations of the memory controller 1200, and perform a logical operation. The processor 710 may communicate with the external host 2000 through the host interface 740, and communicate with the memory device 1100 through the memory interface 760. Also, the processor 710 may communicate with the memory buffer 720 through the buffer control circuit 750. The processor 710 may control an operation of the memory system 1000 by using the memory buffer 720 as a working memory, a cache memory, or a buffer memory.

The processor 710 may queue a plurality of commands input from the host 2000. In this case, a queued command may be referred to as a tag. The processor 710 may sequentially transfer a plurality of queued tags to the memory device 1100. Also, the processor 710 may change an order of the plurality of queued tags for the transfer to the memory device 1100. In other words, the processor 710 may use various methods including order of priority, cross reference, and the like.

The memory buffer 720 may be used as the working memory, the cache memory, or the buffer memory of the processor 710. The memory buffer 720 may store codes and commands, which are executed by the processor 710. The memory buffer 720 may include a static RAM (SRAM) or a dynamic RAM (DRAM).

The ECC circuit 730 may perform an ECC operation. The ECC circuit 730 may perform ECC encoding on data to be written in the memory device 1100 through the memory interface 760. The ECC encoded data may be transferred to the memory device 1100 through the memory interface 760. The ECC circuit 730 may perform ECC decoding on data received from the memory device 1100 through the memory interface 760. As an example, the ECC circuit 730 may be included as a component of the memory interface 760 in the memory interface 760.

The host interface 740 may communicate with the external host 2000 under the control of the processor 710. The host interface 740 may communicate with the host 2000, using at least one of various communication manners, such as a universal serial bus (USB), a serial AT attachment (SATA), a high speed interchip (HSIC), a small computer system interface (SCSI), Firewire, a peripheral component interconnection (PCI), a PCI express (PCIe), a nonvolatile memory express (NVMe), a universal flash storage (UFS), a secure digital (SD), a multimedia card (MMC), an embedded MMC (eMMC), a dual inline memory module (DIMM), a registered DIMM (RDIMM), and a load reduced DIMM (LRDIMM).

The buffer control circuit 750 may control the memory buffer 720 under the control of the processor 710.

The memory interface 760 may communicate with the memory device 1100 under the control of the processor 710. The memory device 760 may communicate a command, an address, and data with the memory device 1100 through a channel.

As an example, the memory controller 1200 may not include the memory buffer 720 and the buffer control circuit 750. The processor 710 may load codes from a nonvolatile memory device (e.g., a read only memory (ROM)) provided inside the memory controller 1200. As another example, the processor 710 may load codes from the memory device 1100 through the memory interface 760.

The memory controller 1200 of the present disclosure may further include a data randomizer 770. The data randomizer 770 may randomize data or de-randomize the randomized data. The data randomizer 770 may perform a data randomizing operation on data to be written in the memory device 1100 through the memory interface 760. The randomized data may be transferred to the memory device 1100 through the memory interface 760. The data randomizer 770 may perform a data de-randomizing operation on data received from the memory device 1100 through the memory interface 760. As an example, the data randomizer 770 may be included in the memory interface 760 as a component of the memory interface 760.

As an example, the bus 780 of the memory controller 1200 may be divided into a control bus and a data bus. The data bus may be configured to transmit data in the memory controller 1200, and the control bus may be configured to transmit control information such as a command and an address in the memory controller 1200. The data bus and the control bus are separated from each other, and may not interfere or influence with each other. The data bus may be coupled to the host interface 740, the buffer control circuit 750, the ECC circuit 730, and the memory interface 760. The control bus may be coupled to the host interface 740, the processor 710, the buffer control circuit 750, the memory buffer 720, and the memory interface 760.

FIG. 3 is a diagram illustrating the memory device of FIG. 1.

Referring to FIG. 3, the memory device 1110 may include a memory cell array 100 that stores data. The memory device 1110 may include peripheral circuits 200 configured to perform a program operation for storing data in the memory cell array 100, a read operation for outputting the stored data, and an erase operation for erasing the stored data. The memory device 1110 may include a control logic 300 that controls the peripheral circuits 200 under the control of the memory controller (1200 of FIG. 1).

The memory cell array 100 may include a plurality of memory blocks MB1 to MBk (k is a positive integer) 110. Local lines LL and bit lines BL1 to BLn (n is a positive integer) may be coupled to the memory blocks MB1 to MBk 110. For example, the local lines LL may include a first select line, a second select line, and a plurality of word lines arranged between the first and second select lines. Also, the local lines LL may further include dummy lines arranged between the first select line and the word lines and between the second select line and the word lines. Here, the first select line may be a source select line, and the second select line may be a drain select line. For example, the local lines LL may include word lines, drain and source select lines, and source lines SL. For example, the local lines LL may further include dummy lines. For example, the local lines LL may further include pipe lines. The local lines LL may be coupled to the memory blocks MB1 to MBk 110, respectively, and the bit lines BL1 to BLn may be commonly coupled to the memory blocks MB1 to MBk 110. The memory blocks MB1 to MBk 110 may be implemented in a two-dimensional or three-dimensional structure. For example, memory cells may be arranged in a direction parallel to a substrate in memory blocks 110 having a two-dimensional structure. For example, memory cells may be arranged in a direction vertical to a substrate in memory blocks 110 having a three-dimensional structure. The memory cells may be nonvolatile memory cells which retain stored data even when power is cut off.

The peripheral circuits 200 may be configured to perform program, read, and erase operations of a selected memory block 110 under the control of the control logic 300. For example, the peripheral circuits 200, under the control of the control logic 300, may supply verify and pass voltages to the first select line, the second select line, and the word lines, selectively discharge the first select line, the second select line, and the word lines, and verify memory cells coupled a selected word line among the word lines. For example, the peripheral circuits 200 may include a voltage generating circuit 210, a row decoder 220, a page buffer group 230, a column decoder 240, an input/output circuit 250, and a sensing circuit 260.

The voltage generating circuit 210 may generate various operating voltages Vop used for program, read, and erase operations in response to an operation signal OP_CMD. Also, the voltage generating circuit 210 may selectively discharge the local lines LL in response to the operation signal OP_CMD. For example, the voltage generating circuit 210 may generate a program voltage, a verify voltage, pass voltages, a turn-on voltage, a read voltage, an erase voltage, a source line voltage, and the like under the control of the control logic 300.

The row decoder 220 may transfer the operating voltages Vop to local lines LL coupled to a selected memory block 110 in response to a row address RADD.

The page buffer group 230 may include a plurality of page buffers PB1 to PBn 231 coupled to the bit lines BL1 to BLn. The page buffers PB1 to PBn 231 may operate in response to page buffer control signals PBSIGNALS. For example, the page buffers PB1 to PBn 231 may temporarily store data received through the bit lines BL1 to BLn, or sense voltages or current of the bit lines BL1 to BLn in a read or verify operation.

The column decoder 240 may transfer data between the input/output circuit 250 and the page buffer group 230 in response to a column address CADD. For example, the column decoder 240 may exchange data with the page buffers 231 through data lines DL, or exchange data with the input/output circuit 250 through column lines CL.

The input/output circuit 250 may transfer a command CMD and address ADD, which are received from the memory controller (1200 of FIG. 1), to the control logic 300, or exchange data DATA with the column decoder 240.

The sensing circuit 260, in a read operation and a verify operation, may generate a reference current in response to a permission bit VRY_BIT<#>, and output a pass signal PASS or a fail signal FAIL by comparing a sensing voltage VPB received from the page buffer group 230 with a reference voltage generated by the reference current.

The control logic 300 may control the peripheral circuits 200 by outputting the operation signal OP_CMD, the row address RADD, the page buffer control signals PBSIGNALS, and the permission bit to VRY_BIT<#> in response to the command CMD and the address ADD. Also, the control logic 300 may determine whether the verify operation has passed or failed in response to the pass or fail signal PASS or FAIL.

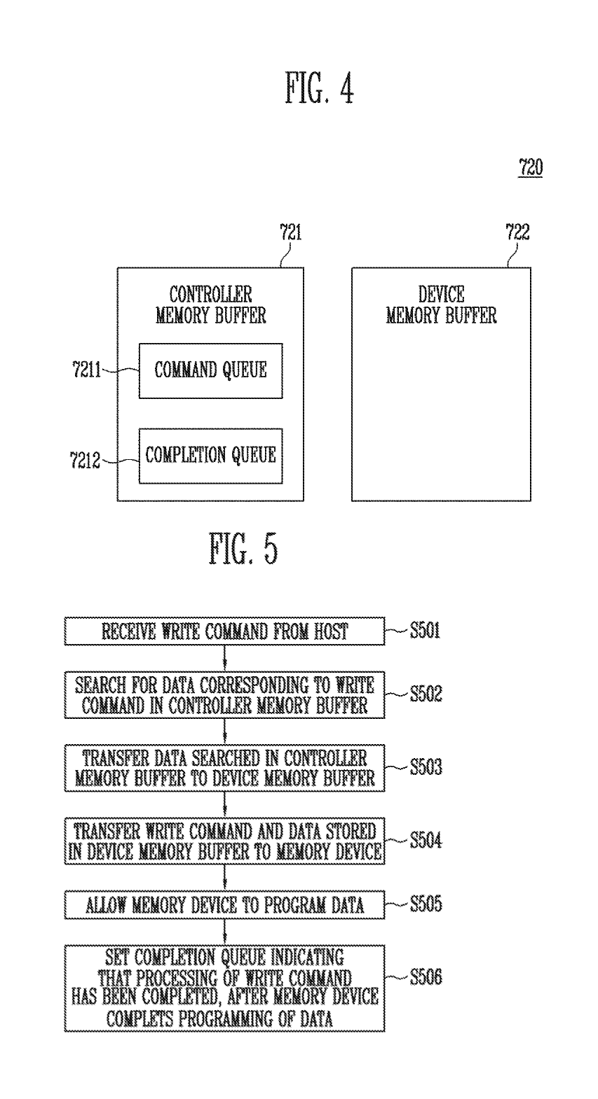

FIG. 4 is a diagram illustrating in detail a memory buffer according to an embodiment of the present disclosure.

Referring to FIG. 4, the memory buffer 720 may include a controller memory buffer 721 and a device memory buffer 722.

The controller memory buffer 721 is a memory space allocated for the host 2000, and is a memory space accessible by the host 2000. In other words, the controller memory buffer 721 is a memory space that exists in the memory system 1000 and is occupied by the host 2000. That is, the host 2000 may temporarily buffer data for a write operation in the controller memory buffer 721, and receive the data buffered in the controller memory buffer 721.

The controller memory buffer 721 may be accessible by the memory controller 1200 of the memory system 1000. The memory controller 1200 may determine whether specific data has been stored in the controller memory buffer 721 in response to a command of the host 2000. Also, the memory controller 1200 may transfer data stored in the device memory buffer 722 to the controller memory buffer 721. The memory controller 1200 may transfer data stored in the controller memory buffer 721 to the device memory buffer 722. In other words, the controller memory buffer 721 may be a space shared by the host 2000 and the memory system 1000.

The device memory buffer 722 is a memory space occupied by the memory system 1000. In other words, the device memory buffer 722 is a memory space that the host 2000 cannot access, and may be a space that the memory system 1000 exclusively occupies with respect to the host 2000.

The controller memory buffer 721 may include a command queue 7211 and a completion queue 7212. The command queue 7211 may queue a plurality of commands input from the host 2000. The memory system 1000 may sequentially process the plurality of commands queued to the command queue 7211 or process the plurality of commands queued to the command queue 7211 by changing the sequence of the plurality of commands, using a method including order of priority, and the like. The memory controller 1200 may set the completion queue 7212 for the processed command. In addition, the host 2000 may check whether the processing of the corresponding command has been completed by checking the completion queue 7212.

The host 2000 may store write data in the controller memory buffer 721 before the host 2000 inputs a write command to the memory system 1000. When the memory system 1000 receives a write command from the host 2000, the processor 710 of the memory controller 1200 may search for write data in the controller memory buffer 721. At this time, the write command may be queued to the command queue 7211. Also, the processor 710 may control the write data searched in the controller memory buffer 721 to be transferred to the device memory buffer 722. Then, the processor 710 may transfer, to the memory device 1100, the write command queued to the command queue 7211 and the write data transferred from the controller memory buffer 721 to the device memory buffer 722, and control the memory device 1100 to perform a program operation, based on the write command and the write data. As another example, the processor 710 may transfer write data stored in the controller memory buffer 721 immediately to the memory device 1100, and perform a program operation, based on the write data transferred from the controller memory buffer 721. After the memory device 1100 completes the program operation, the processor 710 of the memory controller 1200 may set the completion queue 7212 indicating that the processing of the write command has been completed. The host 2000 may check whether the processing of the write command input to the memory system 1000 has been completed by checking the completion queue 7212.

The host 2000 may input read command to the memory system 1000. The memory controller 1200 of the memory system 1000 may first check whether data corresponding to the read command input from the host 2000 has been stored in the completion queue 7212 of the controller memory buffer 721 in response to the read command. That is, the memory controller 1200 may search the completion queue 7212 to check whether data corresponding to the read command has been stored in the completion queue 7212. In other words, the memory system 1000 may use the controller memory buffer 721 as a first cache buffer. When the data corresponding to the read command is searched in the completion queue 7212, i.e., in the case of first cache hit, the memory controller 1200 may immediately set the completion queue 7212 indicating that the processing of the read command has been completed, and the host 2000 may receive the data corresponding to the read command from the completion queue 7212.

When the memory controller 1200 fails to search for the data corresponding to the read command in the completion queue 7212, i.e., first cache miss, the memory controller 1200 may search for the data corresponding to the read command in the device memory buffer 722. In other words, the memory system 1000 may use the device memory buffer 722 as a second cache buffer.

When memory controller 1200 succeeds in searching for the data corresponding to the read command in the device memory buffer 722, i.e., second cache hit, the memory controller 1200 may transfer, to the completion queue 7212, the data corresponding to the read command, which is stored in the device memory buffer 722, and set the completion queue 7212 indicating that the processing of the read command has been completed. Subsequently, the host 2000 may receive the data corresponding to the read command from the completion queue 7212.

When the memory controller 1200 fails to search for the data corresponding to the read command in the device memory buffer 722, i.e., second cache miss, the memory controller 1200 may read the data corresponding to the read command from the memory device 1100. In other words, when the memory controller 1200 fails to search for the data corresponding to the read command in both of the completion queue 7212 and the device memory buffer 722, the memory controller 1200 may read the data corresponding to the read command, which is stored in the memory device 1100. The memory controller 1200 may control the data corresponding to the read command, which is output from the memory device 1100, to be transferred to the completion queue 7212, and set the completion queue 7212 indicating that the processing of the read command has been completed. Subsequently, the host 2000 may receive the data corresponding to the read command from the completion queue 7212.

In other words, when a read command is input from the host 2000, the memory controller 1200 may first search the completion queue 7212 to check whether data corresponding to the read command has been stored in the completion queue 7212 of the controller memory buffer 721. When the memory controller 1200 succeeds in searching for the data corresponding to the read command in the completion queue 7212, the memory controller 1200 may set the completion queue 7212 indicating that the processing of the read command has been completed. Subsequently, the host 2000 may receive the data corresponding to the read command from the completion queue 7212.

When the memory controller 1200 fails to search for the data corresponding to the read command in the completion queue 7212, the memory controller 1200 may search the device memory buffer 722 to check whether the data corresponding to the read command has been stored in the device memory buffer 722. When the memory controller 1200 succeeds in searching for the data corresponding to the read command in the device memory buffer 722, the memory controller 1200 may transfer, to the completion queue 7212, the data corresponding to the read command, which is stored in the device memory buffer 722, and then set the completion queue 7212 indicating that the processing of the read command has been completed. Subsequently, the host 2000 may receive the data corresponding to the read command from the completion queue 7212.

When the memory controller 1200 fails to search for the data corresponding to the read command in the device memory buffer 722, the memory controller 1200 may read the data corresponding to the read command from the memory device 1100. The data corresponding to the read command, which is read from the memory device 1100, may be transferred to the completion queue 7212, and the memory controller 1200 may set the completion queue 7212 indicating that the processing of the read command has been completed. Subsequently, the host may receive the data corresponding to the read command from the completion queue 7212.

In general, the controller memory buffer 721 and the device memory buffer 722 may include a DRAM or SRAM. In other words, data can be read at a higher speed than the memory device 1100. Thus, after the memory controller 1200 searches for the data corresponding to the read command in the completion queue 7212 and the device memory buffer 722, the memory controller 1200 can perform an operation of reading the data corresponding to the read command from the memory device 1100 when the memory controller 1200 fails to search for the data corresponding to the read command.

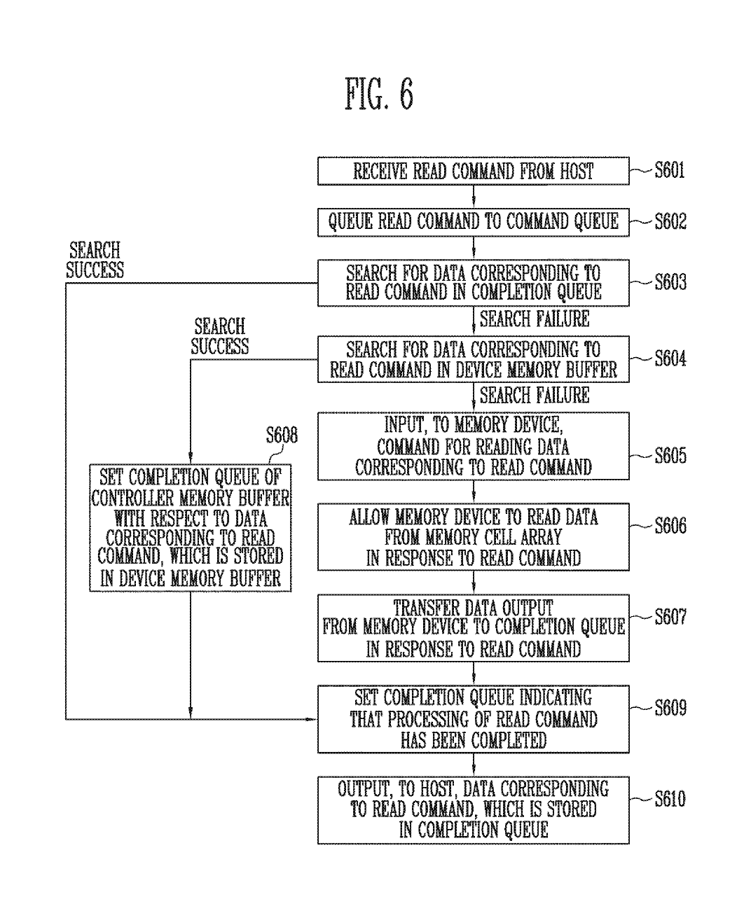

FIG. 5 is a flowchart illustrating a method of processing a write command according to an embodiment of the present disclosure.

Referring to FIG. 5, the memory system 1000 may receive a write command from the host 2000 at step S501.

The memory controller 1200 may perform a step of searching for data corresponding to the write command in the controller memory buffer 721 in response to the write command at step S502. As described above, the host 2000 may store write data in the controller memory buffer 721 before the host 2000 inputs a write command to the memory system 1000.

Then, the memory controller 1200 may perform a step of transferring the data searched in the controller memory buffer 721 to the device memory buffer 722 at step S503.

After the step S503 is performed, the memory controller 1200 may perform a step of transferring the write command and the data stored in the device memory buffer 722 to the memory device 1100 at step S504.

In another embodiment of the present disclosure, the memory controller 1200 may not perform the steps S503 and S504, but instead perform a step of transferring the data searched in the controller memory buffer 721 immediately to the memory device 1100.

Subsequently, the memory device 1100 may perform a step of programming the data in the write command transferred thereto at step S505.

After the memory device 1100 completes the programming of the data, the memory controller 1200 may perform a step of setting the completion queue 7212 indicating that the processing of the write command has been completed at step S506.

FIG. 6 is a flowchart illustrating a method of processing a read command according to an embodiment of the present disclosure.

Referring to FIG. 6, the memory system 1000 may receive a read command from the host 2000 at step S601.

The read command may be queued to the command queue 7211 of the controller memory buffer 721 at step S602.

The memory controller 1200 may perform a step of searching for data corresponding to the read command in the completion queue 7212 of the controller memory buffer 721 in response to the queued read command at step S603.

When the memory controller 1200 succeeds in searching for the data corresponding to the read command in the completion queue 7212 of the controller memory buffer 721, the memory controller 1200 may set the completion queue 7212 indicating that the processing of the read command has been completed at step S609.

Subsequently, the host 2000 may check, from the completion queue 7212, that the processing of the read command has been completed, and receive the data corresponding to the read command, which is stored in the completion queue 7212, from the memory system 1000. In other words, the memory system 1000 may perform a step of outputting, to the host 2000, the data corresponding to the read command, which is stored in the completion queue 7212 at step S610.

When the memory controller 1200 fails to search for the data corresponding to the read command in the completion queue 7212 of the controller memory buffer 721 in the step S603, the processor 710 of the memory controller 1200 may perform a step of searching for the data corresponding to the read command in the device memory buffer 722 at step S604.

When the memory controller 1200 succeeds in searching for the data corresponding to the read command in the device memory buffer 722, the memory controller 1200 may perform a step of transferring the data corresponding to the read command, which is stored in the device memory buffer 722, to the completion queue 7212 of the controller memory buffer 721 at step S608.

Then, the memory controller 1200 may set the completion queue 7212 indicating that the processing of the read command has been completed at step S609.

Subsequently, the host 2000 may check, from the completion queue 7212, that the processing of the read command has been completed, and receive the data corresponding to the read command, which is stored in the completion queue 7212, from the memory system 1000.

When the memory controller 1200 fails to search for the data corresponding to the read command in the device memory buffer 722 in the step S604, the memory controller 1200 may perform a step of inputting, to the memory device 1100, a command for reading the data corresponding to the read command at step S605.

The memory device 1100 may perform an operation of reading the data corresponding to the read command from the memory cell array 100 in response to the read command, and output the read data at step S606.

Also, the memory controller 1200 may perform a step of transferring the data output from the memory device 1100 to the completion queue 7212 of the controller memory buffer 721 at step S607.

Then, the memory controller 1200 may set the completion queue 7212 indicating that the processing of the read command has been completed at step S609.

Subsequently, the host 2000 may check, from the completion queue 7212, that the processing of the read command has been completed, and receive the data corresponding to the read command, which is stored in the completion queue 7212, from the memory system 1000.

As another example, the memory controller 1200 does not transfer the data output from the memory device 1100 immediately to the completion queue 7212 of the controller memory buffer 721, but may transfer the data output from the memory device 1100 to the device memory buffer 722. Then, the memory controller 1200 may transfer the data stored in the device memory buffer 722 to the completion queue 7212 of the memory buffer 721. Then, the memory controller 1200 may set the completion queue 7212 indicating that the processing of the read command has been completed at step S609.

Subsequently, the host 2000 may check, from completion queue 7212, that the processing of the read command has been completed, and receive the data corresponding to the read command, which is stored in the completion queue 7212, from the memory system 1000.

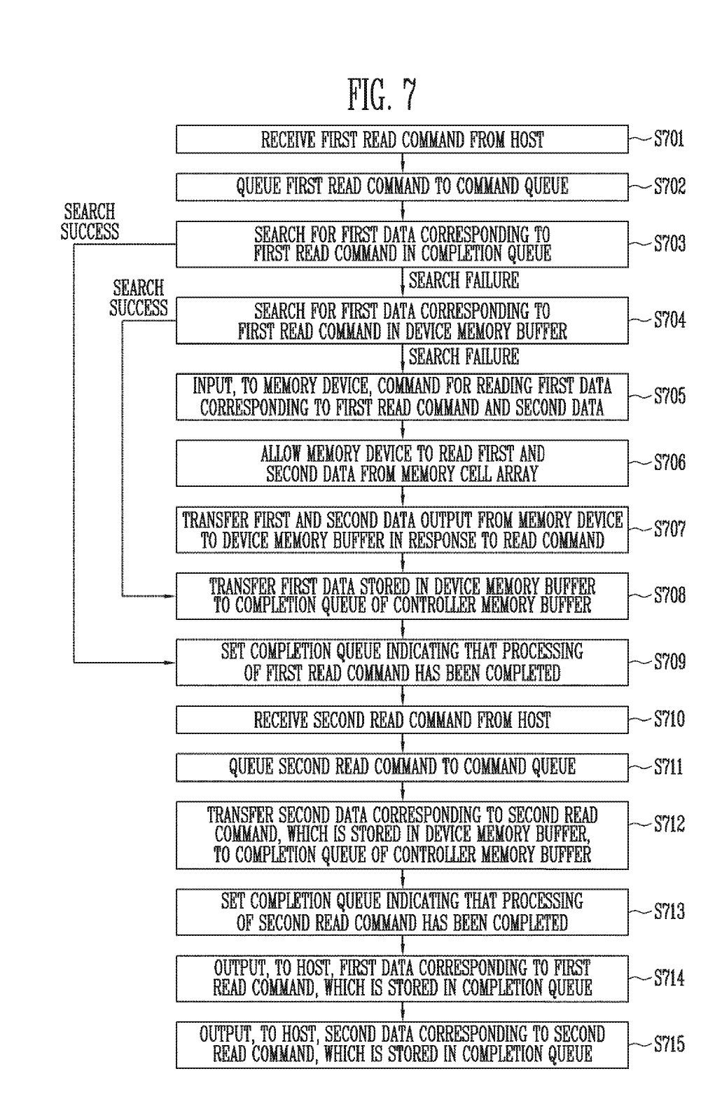

FIG. 7 is a flowchart illustrating a method of processing a read command according to another embodiment of the present disclosure.

Referring to FIG. 7, the memory system 1000 may receive a first read command from the host 2000 at step S701.

The first read command may be queued to the command queue 7211 of the controller memory buffer 721 at step S702.

The memory controller 1200 may perform a step of searching for first data corresponding to the first read command in the completion queue 7212 of the controller memory buffer 721 in response to the first read command at step S703.

When the memory controller 1200 succeeds in searching for the first data corresponding to the first read command in the completion queue 7212 of the controller memory buffer 721, the memory controller 1200 may set the completion queue 7212 indicating that the processing of the first read command has been completed at step S709.

When the memory controller 1200 fails to search for the first data corresponding to the first read command in the completion queue 7212 of the controller memory buffer 721 in the step S703, the processor 710 of the memory controller 1200 may perform a step of searching for the first data corresponding to the first read command in the device memory buffer 722 at step S704.

When the memory controller 1200 succeeds in searching for the first data corresponding to the first read command in the device memory buffer 722, the memory controller 1200 may perform a step of transferring the first data corresponding to the first read command, which is stored in the device memory buffer 722, to the completion queue 7212 of the controller memory buffer 721 at step S708.

Then, the memory controller 1200 may set the completion queue 7212 indicating that the processing of the first read command has been completed at step S709.

When the memory controller 1200 fails to search for the first data corresponding to the first read command in the device memory buffer 722 in the step S704, the memory controller 1200 may perform a step of inputting, to the memory device 1100, a command for reading the first data corresponding to the first read command and second data at step S705.

At this time, the second data may be data different from data that the host 2000 requests through the first read command. Also, the second data may be data read together when the memory device 1100 reads the first data in response to the first read command. For example, the second data may be stored in a page together with a part of the first data. Since the read operation is performed in page units, the second data may be read together when the first data is read. The memory device 1100 may perform an operation of reading together the first data corresponding to the first read command and the second data that does not correspond to the first read command from the memory cell array 100 in response to the first read command, and output the read first and second data at step S706.

In addition, the memory controller 1200 may perform a step of transferring the first and second data output from the memory device 1100 to the device memory buffer 722 at step S707.

Then, the memory controller 1200 may perform a step of transferring the first data stored in the device memory buffer 722 to the completion queue 7212 of the controller memory buffer 721 at step S708.

Subsequently, the memory controller 1200 may perform a step of setting the completion queue 7212 indicating that the processing of the first read command has been completed at step S709.

Then, the memory controller 1200 may receive a second read command from the host 2000. At this time, data corresponding to the second read command may be the second data. In this case, the memory controller 1200 does not perform an operation of searching for the second data in the completion queue 7212 but may immediately perform a step of transferring the second data stored in the device memory buffer 722 to the completion queue 7212 of the controller memory buffer 721 at step S712.

Then, the memory controller 1200 may set the completion queue 7212 indicating that the processing of the second read command has been completed at step S713.

Subsequently, the host 2000 may check, from the completion queue 7212, that the processing of the first read command has been completed, and receive the data corresponding to the first read command, which is stored in the completion queue 7212, from the memory system 1000 at step S714.

Also, the host 2000 may check, from the completion queue 7212, that the processing of the second read command has been completed, and receive the data corresponding to the second read command, which is stored in the completion queue 7212, from the memory system 1000 at step S715.

FIG. 8 is a diagram illustrating an embodiment of the memory system including the memory controller shown in FIG. 2 and the memory device shown in FIG. 3.

Referring to FIG. 8, the memory system 30000 may be implemented as a cellular phone, a smart phone, a tablet PC, a personal digital assistant (PDA), or a wireless communication device. The memory system 30000 may include a memory device 1100 and a memory controller 1200 capable of controlling an operation of the memory device 1100. The memory controller 1200 may control a data access operation of the memory device 1100, e.g., a program operation, an erase operation, a read operation, or the like under the control of a processor 3100.

Data programmed in the memory device 1100 may be output through a display 3200 under the control of the memory controller 1200.

A radio transceiver 3300 may transmit/receive radio signals through an antenna ANT. For example, the radio transceiver 3300 may convert a radio signal receive through the antenna ANT into a signal that can be processed by the processor 3100. Therefore, the processor 3100 may process a signal output from the radio transceiver 3300 and transmit the processed signal to the memory controller 1200 or the display 3200. The memory controller 1200 may program the signal processed by the processor 3100 in the semiconductor memory device 1100.

Also, the radio transceiver 3300 may convert a signal output from the processor 3100 into a radio signal, and output the converted radio signal to an external device through the antenna ANT. An input device 3400 is a device capable of inputting a control signal for controlling an operation of the processor 3100 or data to be processed by the processor 3100, and may be implemented as a pointing device such as a touch pad or a computer mount, a keypad, or a keyboard. The processor 3100 may control an operation of the display 3200 such that data output from the memory controller 1200, data output from the radio transceiver 3300, or data output from the input device 3400 can be output through the display 3200.

In some embodiments, the memory controller 1200 capable of controlling an operation of the memory device 1100 may be implemented as a part of the processor 3100, or be implemented as a chip separate from the processor 3100.

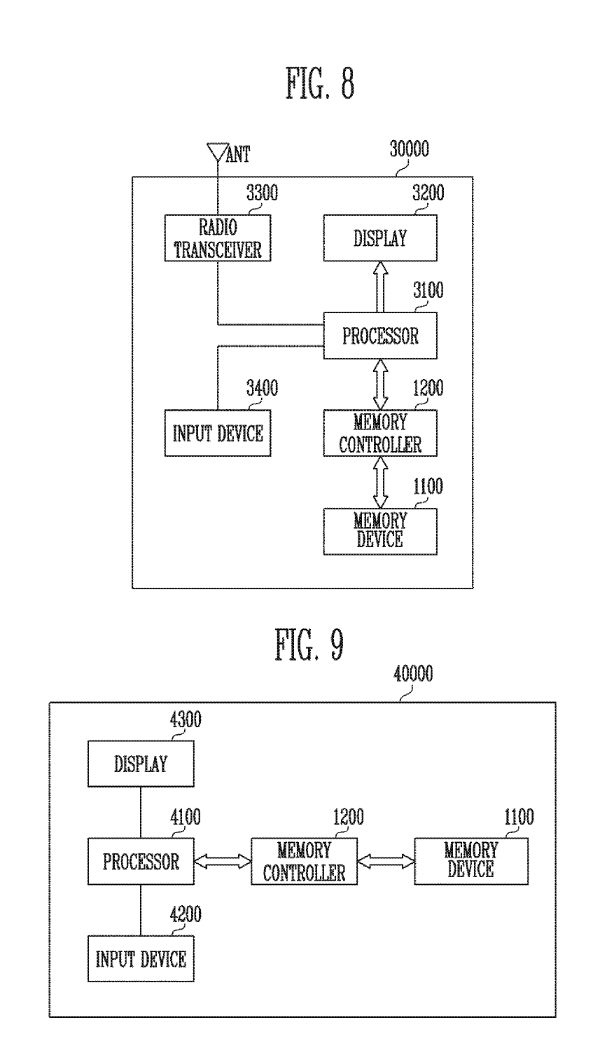

FIG. 9 is a diagram illustrating another embodiment of the memory system including the memory controller shown in FIG. 2 and the memory device shown in FIG. 3.

Referring to FIG. 9, the memory system 40000 may be implemented as a personal computer (PC), a tablet PC, a net-book, an e-reader, a personal digital assistant (PDA), a portable multimedia player (PMP), an MP3 player, or an MP4 player.

The memory system 40000 may include a memory device 1100 and a memory controller 1200 capable of controlling a data processing operation of the memory device 1100.

A processor 4100 may output data stored in the memory device 1100 through a display 4300 according to data input through an input device 4200. For example, the input device 4200 may be implemented as a pointing device such as a touch pad or a computer mouse, a keypad, or a keyboard.

The processor 4100 may control overall operations of the memory system 40000, and control an operation of the memory controller 1200. In some embodiments, the memory controller 1200 capable of controlling an operation of the memory device 1100 may be implemented as a part of the processor 4100, or be implemented as a chip separate from the processor 4100.

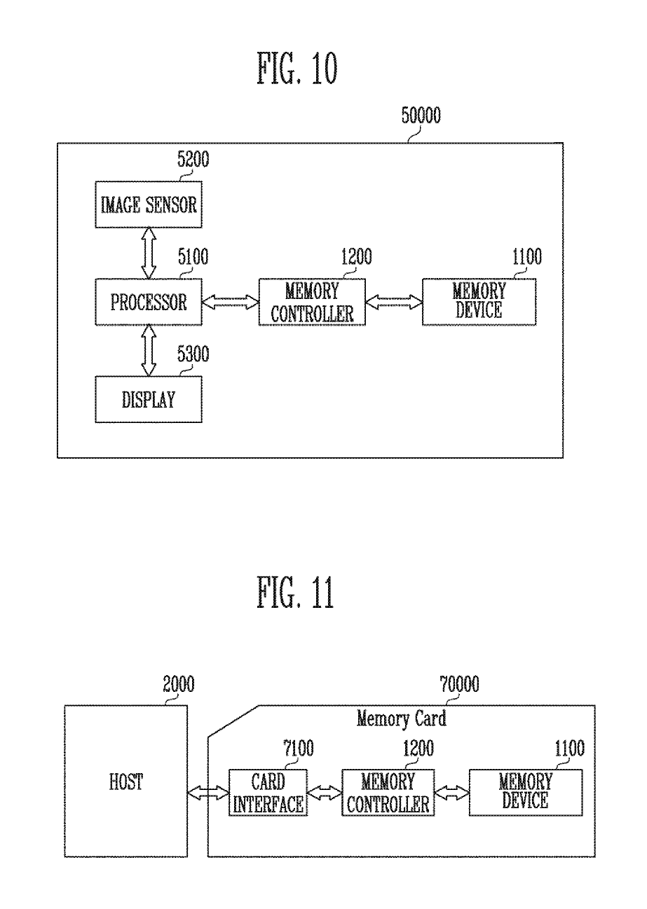

FIG. 10 is a diagram illustrating another embodiment of the memory system including the memory controller shown in FIG. 2 and the memory device shown in FIG. 3.

Referring to FIG. 10, the memory system 50000 may be implemented as an image processing device, e.g., a digital camera, a mobile terminal having a digital camera attached thereto, a smart phone having a digital camera attached thereto, or a tablet PC having a digital camera attached thereto.

The memory system 50000 may include a memory device 1100 and a memory controller 1200 capable of controlling a data processing operation of the memory device 1100, e.g., a program operation, an erase operation, or a read operation.

An image sensor 5200 of the memory system 50000 may convert an optical image into digital signals, and the converted digital signals may be transmitted to a processor 5100 or the memory controller 1200. Under the control of the processor 5100, the converted digital signals may be output through a display 5300, or be stored in the memory device 1100 through the memory controller 1200. In addition, data stored in the memory device 1100 may be output through the display 5300 under the control of the processor 5100 or the memory controller 1200.

In some embodiments, the memory controller 1200 capable of controlling an operation of the memory device 1100 may be implemented as a part of the processor 5100, or be implemented as a chip separate from the processor 5100.

FIG. 11 is a diagram illustrating another embodiment of the memory system including the memory controller shown in FIG. 2 and the memory device shown in FIG. 3.

Referring to FIG. 11, the memory system 70000 may be implemented as a memory card or a smart card. The memory system 70000 may include a memory device 1100, a memory controller 1200, and a card interface 7100.

The memory controller 1200 may control data exchange between the memory device 1100 and the card interface 7100. In some embodiments, the card interface 7100 may be a secure digital (SD) card interface or a multi-media card (MMC) interface, but the present disclosure is not limited thereto.

The card interface 7100 may interface data exchange between a host 60000 and the memory controller 1200 according to a protocol of the host 60000. In some embodiments, the card interface 7100 may support a universal serial bus (USB) protocol and an inter-chip (IC)-USB protocol. Here, the card interface 7100 may mean hardware capable of supporting a protocol used by the host 60000, software embedded in the hardware, or a signal transmission scheme.

According to the present disclosure, when read latency of the memory system can be decreased by performing an operation of searching for whether data corresponding to a read command exists in the controller memory buffer when the read command is input from the host.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A method for operating a memory system, the method comprising:
receiving a read command from a host;
a first search process of searching for data corresponding to the read command in a controller memory buffer; and
a first transfer process of transferring the data to the host,
wherein the controller memory buffer is accessible by the host.

2. The method of claim 1, further comprising a second search process of searching for the data in a device memory buffer,
wherein the second search process is performed when the searching of the data fails in the first search process.

3. The method of claim 1, wherein, when the searching of the data succeeds in the first search process, the data searched in the controller memory buffer is transferred in the first transfer process.

4. The method of claim 2, wherein the device memory buffer is exclusively allocated to the memory system.

5. The method of claim 2, further comprising a second transfer process of transferring the data searched in the device memory buffer to the controller memory buffer,
wherein the second transfer process is performed when the searching of the data succeeds in the second search process.

6. The method of claim 2, further comprising a read process of reading the data from a memory device,
wherein the read process is performed when the searching of the data fails in the second search process.

7. The method of claim 6, further comprising a second transfer process of transferring the data read from the memory device to the controller memory buffer.

8. The method of claim 1, wherein the memory system communicates with the host through a NonVolatile Memory express (NVMe) interface.

9. A method for operating a memory system, the method comprising:
receiving a read command from a host;
a first search process of searching for data corresponding to the read command in a controller memory buffer;
a second search process of searching for the data in a device memory buffer;
a read process of reading the data from a memory device; and
an output process of outputting the data to the host,
wherein the controller memory buffer is occupied by the host.

10. The method of claim 9, wherein the second search process is performed when the searching of the data fails in the first search process.

11. The method of claim 10, wherein the device memory buffer is occupied by the memory system.

12. The method of claim 10, wherein the read process is performed when the searching of the data fails in the second search process.

13. The method of claim 9, further comprising a transfer process of transferring the data read from the memory device to the controller memory buffer.

14. The method of claim 9, wherein the memory system communicates with the host through an NVMe interface.

15. A memory system comprising:
a memory device; and
a memory controller,
wherein the memory controller includes:
a controller memory buffer including a completion queue and a command queue; and
a device memory buffer,
wherein, when a read command is input from a host, the memory controller searches for data corresponding to the read command in the completion queue,
wherein the controller memory buffer is shared by the host and the memory controller.

16. The memory system of claim 15, wherein the memory controller searches for the data in the device memory buffer when the searching of the data in the completion queue fails.

17. The memory system of claim 16, wherein the memory controller reads the data from the memory device when the searching of the data in the device memory buffer fails.

18. The memory system of claim 16, wherein the device memory buffer is exclusively allocated to the memory system.

19. The memory system of claim 16, wherein the controller memory buffer stores data corresponding to a write command input from the host.

20. The memory system of claim 16, wherein the command queue queues the read command.

21. A data processing system comprising:
a memory device; and
a controller suitable for controlling the memory device to perform a read operation in response to a request from a host,
wherein the controller includes:
a second level cache suitable for serving as a cache for the memory device; and
a first level cache suitable for serving as a cache for the second level cache,
wherein the controller stores read data in the first level cache as a result of the read operation, and
wherein the host accesses the first level cache to obtain read data through a nonvolatile memory express (NVMe) interface.
